(19) United States
(12) Patent Application Publication
(10) Pub. No.: US 2025/0164336 A1
(43) Pub. Date: May 22, 2025

(54) LEAK DETECTION DEVICE AND LEAK DETECTION METHOD FOR SNIFFER LEAK DETECTION

(71) Applicant: INFICON GmbH, Köln (DE)

(72) Inventor: Rene Bausch, Köln (DE)

(21) Appl. No.: 18/842,970

(22) PCT Filed: Jan. 17, 2023
(86) PCT No.: PCT/EP2023/050961

§ 371 Date: Aug. 30, 2024

(30) Foreign Application Priority Data
Mar. 9, 2022 (DE) 10 2022 105 553.1

(51) Int. Cl. G01M 3/00; G01M 3/20

(52) U.S. Cl. CPC G01M 3/007; G01M 3/202; G01M 3/207

(57) ABSTRACT

In a leak detection device (10) comprising a gas detector and a guided sniffer probe (12) connected to the gas detector in a gas-conducting manner, it is provided that the sniffer probe (12) is provided with a receiver (18) configured to receive first data provided on a test specimen (28) or transmitted by a test specimen (28) with first information on properties of the test specimen (28) which are relevant for leak detection with the gas detector.

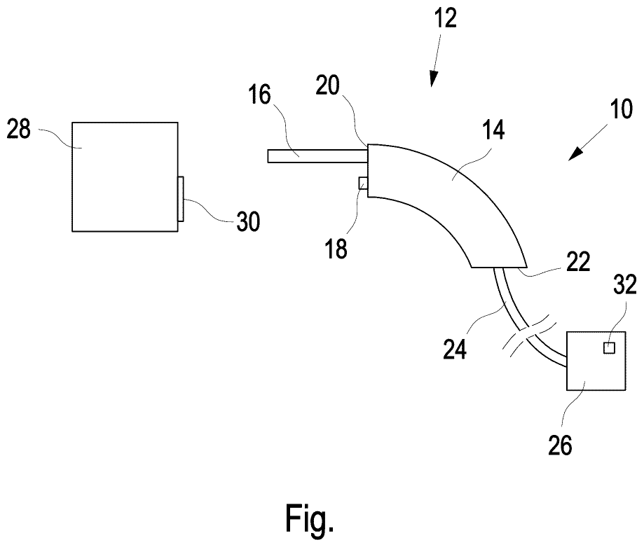

The invention relates to a leak detection device and a leak detection method for sniffer leak detection.

In sniffer leak detection, a gas flow is drawn in by a hand-guided sniffer probe and fed to a gas detector for gas analysis. The sniffer probe is used to draw in gas from the environment of the test specimen to infer the presence of a leak and the size of a possible leak based on the gas analysis.

To calibrate a leak detector with a separate test leak device used as a test specimen, the operator needs to enter parameters of the test leak device's test leak, such as the value of the leak rate and/or the type of test gas, into the gas detector's base device to be able to perform the calibration procedure. In doing so, the resulting measurement signal is assigned to the manually entered leak rate. Meanwhile, there are gas type-related peculiarities which can lead to errors, confusion or incorrect entries during calibration. Also, when examining different types of test specimens where the size of a leak is not known, such as in the case of cooling devices (refrigerators, air conditioning, etc.), information on properties of the test specimen is often important when evaluating the measurement signal of the gas detector in order to obtain a meaningful measurement result from the measurement signal.

Against this background, the object of the invention is to provide an improved leak detection device and an improved leak detection method.

The invention is defined by the independent claims. The dependent claims define embodiments of the invention.

The invention provides that the hand-guided or robot-guided sniffer probe is provided with a receiver which is configured to receive first data stored on the test specimen side with first information on properties of the test specimen which are important for the evaluation of the measurement signal of the leak detector, and to take this data into account during gas detection.

The first information may be the leak rate of the leak in the test specimen, the age of the test specimen, the temperature of the test specimen or of the test fluid or test gas contained in the test specimen, or the test fluid or test gas.

The test specimen may be a test leak device with a leak of known size.

The receiver may be a radio receiver, e.g. a RFID reader, a Bluetooth receiver or an infrared receiver, or an optical reading device such as a barcode scanner or an optical camera.

The first data with the first information may be stored on the test specimen in an electronic memory provided on the test specimen, wherein in this case the first data is electronic data in which the first information is stored in coded form. Alternatively or additionally, the first data may be optically coded data, such as a barcode, DataMatrix code, QR code, or characters/symbols attached to the exterior of the test specimen and containing the first information in coded form.

On the detector side, a second memory may be provided in which second data with second information on respectively different first information is stored, for example in the form of a table or a matrix. In this respect, various first data or information are assigned respective associated second data or information. Thus, from the received first information on properties of the test specimen, depending on the received first information, a respective second information can be read out from the second memory, which is important for the evaluation or interpretation of the measurement signal of the gas detector.

For example, the first information may be the type of test fluid or test gas contained in the test specimen, wherein the second memory stores molecular masses associated with various test fluids or test gases, which, in the case of a mass spectrometric gas detector, are important when evaluating the measurement signal for leak detection.

Alternatively or additionally, the second information may be information on possible interactions with gases from the test environment, which must be taken into account when evaluating the leak rate measurement. Furthermore, the second information may be a suitable rejection limit, which states which permissible leak rate assigned to the test gas must not be exceeded at the test specimen. If this read-in rejection limit is exceeded during measurement on a test specimen, a warning can be issued indicating a “bad part”. Furthermore, the second information may indicate the test leak rate and/or test leak gas type. For example, the optimal operating conditions for the mass spectrometer (mass line width, signal gain factor, . . . ) can be specified and assigned to the first information.

For leak detection systems that detect the test gas optically, e.g. via a spectroscopic measurement of the wavelengths absorbed or emitted by the test gas, the second information may be the wavelength range suitable for detecting the respective leak gas, which must be evaluated for leak rate determination.

The second data may be stored at the gas detector in an electronic memory, the second data being electronic data in which the second information is contained in coded form. Alternatively or additionally, the second data may be optically coded data, such as a barcode, or characters/symbols attached to or in the gas detector and containing the second information in coded form.

In the following, an exemplary embodiment of the invention is explained in detail with reference to the FIGURE. The FIGURE shows a block diagram of the exemplary embodiment.

The leak detection device 10 of the illustrated exemplary embodiment comprises a hand-guided sniffer probe 12 having a handle 14 and a sniffer probe 16 extending from the handle 14. In addition to the sniffer probe 16, a receiver 18 is arranged on the handle 14. The receiver 18 points from a distal end 20 of the handpiece 14 in the same direction as the sniffer tip 16. The proximal end 22 opposite the distal end 20 is connected to a conventional gas detector 26 via a gas-conducting connection line 24. The gas detector 26 may be a partial pressure sensor in vacuum mode with a vacuum pump not illustrated in the FIGURE, which generates a vacuum pressure to draw in gas from the external environment of the sniffer tip 16. In particular, the gas detector 26 may be a mass spectrometer.

The test specimen 28 is filled with a test gas that is not illustrated in the FIGURE. The test specimen has a leak that is not illustrated in the FIGURE. The test specimen may be a test leak device with known test gas and the leak may be a test leak of known size for calibrating the leak detection device 10. Alternatively, the test specimen 28 may be a cooling device such as a refrigerator or an air conditioning.

The test specimen is provided with a memory 30, which may be an electronic data memory or optical information, e.g. in the form of a sticker or an imprint on an outer surface of the test specimen 28. The first memory 30 stores first information on properties of the test specimen 28 in coded form. This may be information on the leak rate or the size of the leak in the test specimen, on age or temperature of the test specimen or the test fluid inside the test specimen 28, or on the test gas or test fluid in the test specimen 28. The first information is important when evaluating the measurement signal of the gas detector 26 in order to reliably infer the presence and size of a possible leak from the measurement signal.

For this purpose, the receiver 18 receives the data from the first memory 30 when the sniffer probe 12 approaches the test specimen 28, for example, by the receiver 18 being a radio receiver and receiving the first data in the form of a radio signal (RFID, Bluetooth, infrared, WiFi, etc.). Alternatively, the receiver 18 may be an optical reading device, for example, with a camera or a barcode scanner that scans the data.

The sniffer probe 14 is approached to the test specimen 28. When the distance to the test specimen 28 falls below a specific distance, when a signal amplitude of the data signal received with the receiver 18 with the first data increases or is exceeded a, or when an actuating button on the sniffer probe 12 not illustrated in the FIGURE is actuated, the data transmission from the first memory 30 to the receiver 18 or the reception of the first data with the receiver 18 is initiated. The received first data are then transmitted to an evaluation device 32 of the leak detection device 10. For this purpose, the evaluation device 32 is electronically connected by wire or wirelessly to the receiver 18.

In the illustrated exemplary embodiment, the evaluation device 32 is provided on the gas detector 26. The evaluation device 32 includes two data memories in which second data are stored in the form of a tabular matrix. In this respect, second information associated with various first information is respectively stored, which is important for the evaluation of the measurement signal of the gas detector 26 for the detection of a leak in the test specimen 28.

When gas is drawn in from the environment of the test specimen 28 by the sniffer tip 16 and fed to the gas detector 26, the gas detector 26 analyzes the drawn-in gas in consideration of the received first information and/or in consideration of the second information. For example, if the first information is the leak rate of a test leak on the test specimen 28, the evaluation device 32 can perform a calibration of the leak detector 26 by assigning the received leak rate to the measurement signal. The first information may also be the type of test gas used in the test specimen 28, wherein the second information indicate, for example, the respective molecular mass if the gas detector 26 is a mass spectrometer. It is also conceivable that in the case where the first information indicates the type of test fluid present in the test specimen, for example a particular coolant in a cooling device, the evaluation device 32 assigns a specific threshold value as the second information associated with the first information. If the measurement signal of the gas detector 26 exceeds said gas type-specific threshold value, a gas leak is assumed to be detected and indicated to the user.

1-15. (canceled)

16. A leak detection device comprising a gas detector and a sniffer probe connected to the gas detector in a gas-conductive manner,
wherein the sniffer probe is provided with a receiver configured to receive first data, provided on a test specimen or transmitted by a test specimen, with first information on properties of the test specimen which are relevant for leak detection with the gas detector.

17. The leak detection device according to claim 16, wherein the receiver is a radio receiver or an optical receiver.

18. The leak detection device according to claim 16, wherein the first data are stored as electronic data in a first digital memory of the test specimen or are attached to the test specimen as optically readable coded data, e.g. in the form of a barcode, DataMatrix code or QR code.

19. The leak detection device according to claim 16, wherein the properties are the leak rate or the size of the leak to be detected, a test fluid contained in the test specimen, the age or the temperature of the test specimen, or the age or the temperature of a test fluid contained in the test specimen.

20. The leak detection device according to claim 16, wherein the test specimen is a test leak device with a test leak of known size for calibrating the leak detector.

21. The leak detection device according to claim 16, wherein the test specimen is a cooling device such as a refrigerator or an air conditioning.

22. The leak detection device according to claim 16, wherein the leak detection device is provided with a second memory which contains, in addition to various first information items stored on test specimen and to be received by the receiver, respective second information from which the gas detector selects at least one respective second information depending on the transmitted first information in order to carry out the gas detection with reference to the transmitted first information of the test specimen.

23. The leak detection device according to claim 16, wherein the gas detector is a mass spectrometer, the first information is the test fluid and the second information is the respective molecular mass for each test fluid, wherein the memory of the gas detector stores for different test fluids the respective molecular masses of the gas detector to be evaluated.

24. The leak detection device according to claim 22, wherein the gas detector is an optical spectroscopic gas detector, the first information is the test fluid and the second information is the respective wavelength range for each test fluid, wherein the memory of the gas detector stores for different test fluids the respective wavelength ranges of the gas detector to be evaluated.

25. The leak detection device according to claim 16, wherein the leak detection device comprises an evaluation device configured to obtain the first data from the first memory when the distance between the sniffer probe and the test specimen falls below a specific distance, when a signal amplitude of the signal received with the receiver increases or is exceeded, or when an actuating button on the sniffer probe is actuated.

26. A combination of a leak detection device according to claim 16 and a test specimen having a memory containing the first information.

27. A method for leak detection with a leak detection device according to claim 16 and a test specimen to be examined having a first memory in which first data with first information on properties of the test specimen are stored, comprising the following steps:
approaching the sniffer probe to the test specimen,
drawing in gas from the environment of the test specimen by the sniffer probe,
receiving the first data from the first memory of the test specimen with the receiver of the sniffer probe,
analyzing the drawn in gas with the gas detector taking into account the first information from the received first data.

28. The method according to claim 27, wherein measured values determined from the measurement signal of the gas detector are compared with the received first information in order to perform a calibration of the leak detector.

29. The method according to claim 27, wherein second data with respective second information are read out from a second memory of the gas detector depending on the received first information, in order to evaluate the measurement signal of the gas detector depending on the read-out second information.

30. The method according to claim 27, wherein, when the distance to the test specimen falls below a specific distance, when a signal amplitude of the data signal received with the receiver with the first data increases or is exceeded, or when an actuating button on the sniffer probe is actuated, the receiver receives the first data from the first memory and transmits said data to an evaluation device of the leak detection device.
